(19) United States
(12) Patent Application Publication
(10) Pub. No.: US 2017/0024297 A1
(43) Pub. Date: Jan. 26, 2017

(54) Storage Device and Data Save Method

(71) Applicant: Kabushiki Kaisha Toshiba, Tokyo (JP)

(72) Inventor: Keigo Sogabe, Yokohama Kanagawa (JP)

(21) Appl. No.: 14/932,725

(22) Filed: Nov. 4, 2015

Related U.S. Application Data
(60) Provisional application No. 62/195,530, filed on Jul. 22, 2015.

(51) Int. Cl. G06F 11/20; G06F 3/06

(52) U.S. Cl. CPC G06F 11/2094; G06F 3/0619; G06F 3/0647; G06F 3/0685; G06F 2201/805; G06F 2201/82; G06F 2201/885

(57) ABSTRACT

A storage device according to the present embodiment is connected to a host device and includes a controller. The controller stores data from the host device in a non-volatile storage unit after storing the data in a cache memory. The controller backs up the data in the cache memory onto a non-volatile memory using an auxiliary power source when power loss occurs. Furthermore, the controller adjusts the set size of the cache memory based on the device temperature near the storage device and the writing speed at which data is written to the non-volatile memory.

### CROSS-REFERENCE TO RELATED APPLICATIONS

This application is based upon and claims the benefit of priority from U.S. Provisional Application No. 62/195,530, filed on Jul. 22, 2015; the entire contents of which are incorporated herein by reference.

### FIELD

Embodiments described herein relate generally to a storage device and a data save method.

### BACKGROUND

The data size of a cache in a media is determined as a fixed value in a worst environmental condition in which it is estimated that margin increases with reference to an experimental values. Thus, the cache stores only a small amount of cache data in comparison with actual capacity value of the cache size. Thus, caching function is not sufficiently used to exert operation performance of a storage device.

### BRIEF DESCRIPTION OF THE DRAWINGS

FIG. 1 is a schematic block diagram of an exemplary configuration of a storage device according to an embodiment;

FIG. 2 is an explanatory diagram of a PLP operation;

FIG. 3 is a flowchart of a process for saving data when the storage device is first powered on;

FIGS. 4A and 4B are diagrams of exemplary configurations of initial tables;

FIG. 5 is a flowchart of a process for saving data when the storage device is powered on for the second and subsequent times; and

FIGS. 6A and 6B are diagrams of exemplary configurations of update tables.

### DETAILED DESCRIPTION

A storage device is provided according to the present embodiment. The storage device is connected to a host device. The storage device includes a non-volatile storage unit that stores data from the host device, and a cache memory that temporarily stores the data before the data is stored in the non-volatile storage unit. The storage device further includes a non-volatile memory that backs the data in the cache memory up using an auxiliary power source when power loss occurs. The storage device further includes a controller. The controller stores data from the host device in the non-volatile storage unit after storing the data in the cache memory. The controller backs the data in the cache memory up onto the non-volatile memory using an auxiliary power source when the power loss occurs. Furthermore, the controller adjusts the set size to be set in the cache memory in accordance with the device temperature near the storage device and the writing speed at which data is written to the non-volatile memory.

The storage device and data save method according to an embodiment will be described in detail with reference to the appended drawings. Note that the present invention is not limited to the embodiment.

### Embodiment

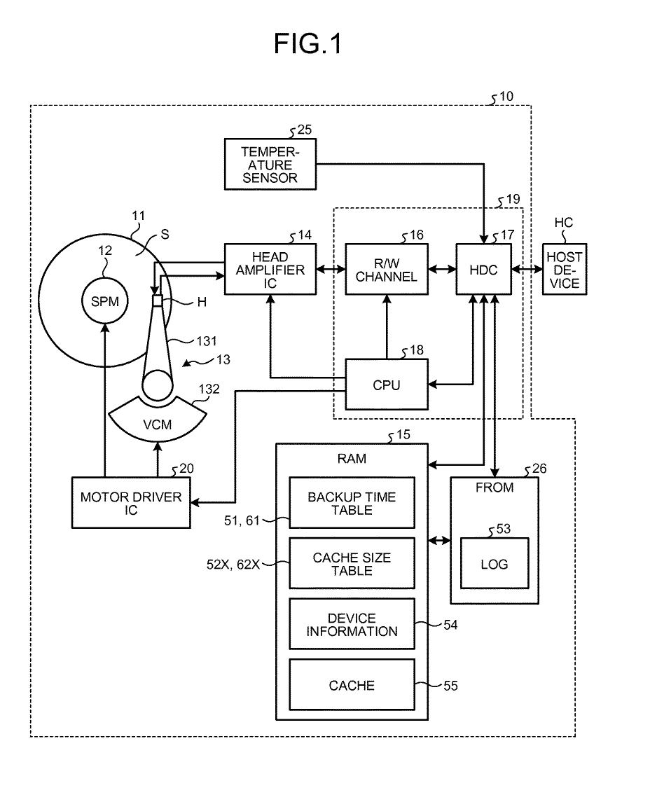

FIG. 1 is a schematic block diagram of an exemplary configuration of a storage device according to an embodiment. The storage device may be a disk device, or a device other than a disk device (for example, a Solid State Drive (SSD)). An example in which the storage device is a disk device will be described in a present embodiment. A Hard Disk Drive (HDD) may be described as an example of a disk device 10.

When Power Loss occurs, the disk device 10 according to the present embodiment adjusts the cache size (a set size) of a cache 55 in accordance with a device temperature, the number of platters, and a writing speed at which data is written to a backup memory (FROM 26).

The disk device 10 is connected to a host device HC. The disk device 10 includes a disk 11 that is a non-volatile storage device, a spindle motor 12, a Head Stack Assembly (hereinafter, referred to as an HSA) 13, and a head amplifier integrated circuit (hereinafter, referred to as a head amplifier IC) 14. The disk device 10 further includes a Random Access Memory (hereinafter, referred to as a RAM) 15, a read and write channel (hereinafter, referred to as an R/W channel) 16, a Hard Disk Controller (hereinafter, referred to as an HDC) 17, and a Central Processing Unit (hereinafter, referred to as a CPU) 18 that is an exemplary processor. The disk device 10 further includes a motor driver IC (SVC) 20, a temperature sensor 25, and the FROM 26.

The disk 11 includes a recording surface S on which data is recorded, and is rotated and driven by the spindle motor 12. The disk device 10 is provided with a plurality of disks (platters) 11. Physical addresses that are the positional information indicating physical positions on the recording surfaces S are set on all of the recording surfaces S included in the disk device 10. The physical address may be assigned for each sector. The spindle motor 12 is driven by current (or voltage) supplied from the motor driver IC 20.

The HSA 13 includes a head H, a head suspension 131, and a Voice Coil Motor (hereinafter, referred to as a VCM) 132. The head H is provided on each of the recording surfaces S of the disks 11. The head H includes a write head used to write data to the disk 11, and a read head used to read the data from the disk 11.

The head suspension 131 is provided for each of the heads H to support the heads H. The VCM 132 is driven by current (or voltage) supplied from the motor driver IC 20. The head suspension 131 and the VCM 132 configure an actuator. The actuator controls the movement of the head H supported on the head suspension 131 to a particular position on the recording surface S of the disk 11 by driving the VCM 132. Configuring the HSA 13 as described above enables the head H to move in a radial direction on the recording surface S of the disk 11.

The head amplifier IC 14 flows a write signal (current) appropriate for the write data input from the R/W channel 16 to the head H. The head amplifier IC 14 amplifies the read signal output from the head H (the read data read from the disk 11 by the head H), and transfers the amplified read signal to the R/W channel 16.

The temperature sensor 25 detects a device temperature that is the temperature near the disk device 10. The temperature sensor 25 detects the device temperature at predetermined intervals of time, and transmits the detected device temperature to the HDC 17. The Flash ROM (FROM) 26 is used as backup non-volatile memory when Power Loss occurs. The disk device 10 backs the information in the RAM 15 and a log 53 up onto the FROM 26 using an auxiliary power source when the Power Loss occurs.

The RAM 15 is used as a temporal storage region. A volatile memory such as a Dynamic RAM (DRAM) or a Static RAM (SRAM) is used as the RAM 15. The RAM 15 stores backup time tables 51 and 61, cache size tables 52X and 62X, device information 54, and the data in the cache 55 (cache data).

The device information 54 stores, for example, the number of platters of the disks 11 included in the disk device 10, and the worst specification value of the writing speed. The cache 55 is the cache memory used to read and write data between the host device HC and the disk 11. The cache 55 temporarily stores the data between the host device HC and the disk 11 before the data is stored in the disk 11.

When the disk device 10 is powered on, information is read from the disk 11 or the FROM 26 and stored in the RAM 15. The information stored in the RAM 15 is overwritten as necessary.

In the information stored in the RAM 15, the backup time table 51, the cache size table 52X, and the device information 54 are not overwritten. The tables and information is generated (in a production step) before the disk device 10 is used, and stored in the disk 11 or the FROM 26.

In the information stored in the RAM 15, the backup time table 61 and the cache size table 62X are overwritten (updated), for example, in accordance with the state of the disk device 10. The tables are generated and updated when the disk device 10 is used.

The backup time tables 51 and 61 store a set backup time in accordance with the combination of device temperatures and the number of platters. The set backup time is the period of time in which the data in the cache 55 can be backed up on the FROM 26 when Power Loss occurs. Note that a period of time shorter than the actual period of time in which the data can be backed up can be set as the set backup time.

The backup time table 51 stores the initial values of the set backup times. The backup time table 61 stores the set backup times based on the actual backup time that is the period of time in which the data is actually backed up. Thus, the backup time table 61 does not store a set backup time in the initial state. The set backup time is overwritten in the backup time table 61 in accordance with the actual backup time.

The cache size tables 52X and 62X store the backup size in accordance with the combination of the device temperatures and the number of platters at each writing speed at which data is written to the FROM 26. The backup size is the cache size that can be set in the cache 55. The backup size is the size of data in the cache 55 that can be backed up onto the FROM 26 when Power Loss occurs. Note that the backup size can be set at a size smaller than the actual size of data that can be backed up.

Hereinafter, the backup time table 51 and cache size table 52X in which initial values are set are sometimes referred to as initial tables. On the other hand, the backup time table 61 and cache size table 62X that are to be updated, for example, in accordance with the state of the disk device 10 are sometimes referred to as update tables.

The RAM 15 is provided with a cache (buffer) 55. The cache 55 includes a write cache and a read cache. The write cache temporarily stores the data to be written into the disk 11 in response to a write command that gives an instruction for writing write data to the disk 11. The read cache temporarily stores the data to be read from the disk 11 in response to a read command that gives an instruction for reading read data from the disk 11.

The sizes corresponding to the backup sizes in the cache size tables 52X and 62X are set in the cache 55 in the present embodiment. Note that an example in which sizes identical to the backup sizes in the cache size tables 52X and 62X are set in the cache 55 will be described hereinafter. Each of the backup sizes is calculated in accordance with the writing speed to the FROM 26 and the set backup time.

In this example, the write command includes the starting Logical Block Address (hereinafter, referred to as an LBA) of the logical sectors to which the write data is to be written in the logical sectors managed in the disk 11, and the length of the write data. The read command includes the starting LBA of the logical sectors in which the read data to be read is stored in the logical sectors managed in the disk 11, and the length of the read data.

The HDC 17 is a communication interface that allows the communication with the host device HC. The HDC 17 stores the data from the host device HC in the cache 55, and then stores the data in the disk 11. If Power Loss occurs, the HDC 17 backs the data in the cache 55 up onto the FROM 26 using an auxiliary power source.

When receiving a write command from the host device HC, the HDC 17 stores the write command in the RAM 15, and stores the write data in the cache 55 of the RAM 15. When the writing process is completed, the HDC 17 sends a response to the host device HC. When receiving a read command from the host device HC, the HDC 17 stores the read command in the RAM 15, and returns the read data stored in the cache 55 in the reading process to the host device HC.

The CPU 18 is the main controller of the disk device 10, and performs various processes including a process for controlling the writing of write data and reading of read data with the head H, and a servomechanism controlling process for controlling the position of the head H on the recording surface S of the disk 11. Note that the CPU 18 performs the various processes with programs stored in non-volatile storage media such as a Read Only Memory (ROM) (not illustrated) and the disk 11.

The motor driver IC 20 controls the electricity (power) in the disk device 10. The motor driver IC 20 controls the power source and controls the spindle motor (SPM) 12. When controlling the power source, the motor driver IC 20 receives the electric power source from the host device HC, and supplies the power source in accordance with the received electric power source to each unit in the disk device 10. To control the spindle motor 12, the motor driver IC 20 controls the rotation of the spindle motor 12. The motor driver IC 20 further controls the driving of the VCM 132.

The motor driver IC 20 detects the occurrence of the Power Loss in the power source from the host device HC. The Power Loss is the disconnection of the electric power source, or the reduction in electricity (the disconnection of the power source from an external power source) in which the electricity becomes too low to continue the operation of the disk device 10.

When detecting an occurrence of Power Loss, the motor driver IC 20 notifies the HDC 17 of the occurrence of Power Loss and receives a back electromotive force caused by the rotation of the spindle motor 12. The motor driver IC 20 supplies the auxiliary power source generated based on the received back electromotive force to each unit in the disk device 10. When detecting an occurrence of Power Loss, the HDC 17 saves the data from the cache 55 to the FROM 26 using the auxiliary power source.

The R/W channel 16, HDC 17, and CPU 18 of the disk device 10 are integrated into the integrated circuit 19 referred to as a System on Chip (SoC) integrated into a chip. The integrated circuit 19 functions as the controller in a broad sense.

When Power Loss occurs, the HDC 17 according to the present embodiment adjusts the size of the cache 55 in accordance with the latest device temperature, the number of platters in the disk device 10, the writing speed to the FROM 26, and the cache size tables 52X and 62X. When Power Loss occurs, the HDC 17 specifically specifies the cache size appropriate for the latest device temperature, the number of platters in the disk device 10, and the writing speed to the FROM 26 among the cache size tables 52X and 62X. Subsequently, the HDC 17 sets the specified cache size as the cache size of the cache 55.

Furthermore, the HDC 17 according to the present embodiment updates the backup time table 61 in accordance with the latest device temperature, the number of platters in the disk device 10, and the actual backup time. The HDC 17 further updates the cache size table 62X in accordance with the latest device temperature, the number of platters in the disk device 10, the backup time table 61, and the actual value of the writing speed to the FROM 26. Specifically, the HDC 17 specifies the set backup time appropriate for the latest device temperature, and the number of platters in the disk device 10 from the backup time table 61. Subsequently, the HDC 17 calculates the cache size by multiplying the specified set backup time by the actual value of the writing speed to the FROM 26. The HDC 17 stores the calculated cache size in an appropriate place in the cache size table 62X.

As described above, the HDC 17 specifies the cache size using the cache size tables 52X and 62X when Power Loss occurs. Furthermore, the HDC 17 stores the actual backup time when the Power Loss occurs in the backup time table 61 to update the cache size table 62X in accordance with the backup time table 61.

A backup is made in the disk device 10 when Power Loss occurs. The backup is made by a Power Loss Protection (PLP) technology. The HDC 17 performs a PLP control in the disk device 10. The PLP control is for saving the data written in a write process to the FROM 26 in order to prevent the data from disappearing when Power Loss occurs in the write process.

The amount of auxiliary power source available when Power Loss occurs is limited in a PLP control. Thus, the amount of data backed up onto the FROM 26 is also limited. In the present embodiment, the size of the cache 55 is optimized, for example, in accordance with the device temperature.

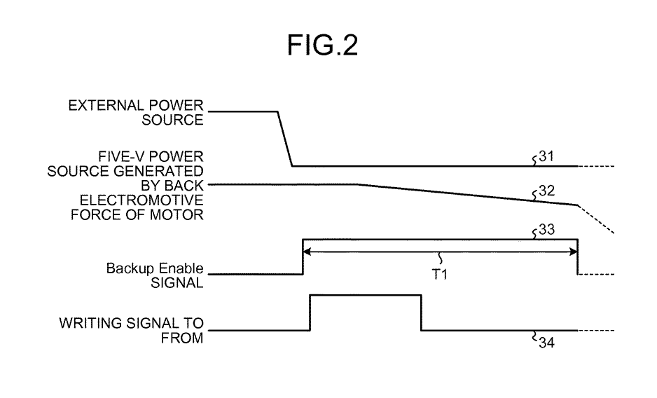

FIG. 2 is an explanatory diagram of a PLP operation. The PLP uses the back electromotive force (for example, five V) of the spindle motor (HDD motor) 12 when Power Loss occurs. In the PLP, the period of time when a voltage of five V is maintained is the time when the data can be backed up.

A characteristic 31 illustrated in FIG. 2 shows the progression of the electricity of the external power source. A characteristic 32 shows the progression of the electricity of the five-V power source generated by the back electromotive force of the motor. When Power Loss occurs in the external power source, the motor driver IC 20 detects Power Loss. Subsequently, the motor driver IC 20 receives the back electromotive force by the rotation of the spindle motor 12, and supplies the received back electromotive force as an auxiliary power source to each unit in the disk device 10.

The motor driver IC 20 outputs a Backup Enable signal to the HDC 17 while the back electromotive force is larger than a predetermined value after Power Loss occurs. A signal 33 shows the progression of the Backup Enable signal. The data (cache data) in the cache 55 can be backed up onto the FROM 26 while the signal 33 is ON. In other words, an Assert period T1 in which the Backup Enable signal is ON is the time in which the data can be backed up onto the FROM 26.

The HDC 17 makes a backup of the cache data using a part or all of the Assert period T1. A signal 34 shows the progression of the writing signal to the FROM 26. The signal 34 is ON while the HDC 17 makes a backup of the cache data. The signal 34 is OFF while the HDC 17 does not make a backup of the cache data. The disk device 10 makes a backup by saving the cache data to the FROM 26 that is a non-volatile memory during the time in which the data can be backed up (the Assert period T1).

The back electromotive force of the motor when Power Loss occurs is used in the PLP control. Thus, the period in which the voltage of five V is maintained is the time in which the data can be backed up. The disk device 10 makes a backup by saving the cache data to the FROM 26 during the time in which the data can be backed up. Thus, the cache size that is still available while the backup is secured depends on the time in which the data can be backed up and the writing speed to the FROM 26. It is also known that the time in which the data can be backed up depends on the number of platters in the medium and the device temperature. Thus, by multiply the time in which the data can be backed up by the writing speed to the FROM 26, an appropriate cache size can be specified.

A process for saving data when Power Loss occurs will be described next. Hereinafter, a process for saving data when the disk device 10 is first powered on, and a process for saving data when the disk device 10 is powered on for the second and subsequent times will be described.

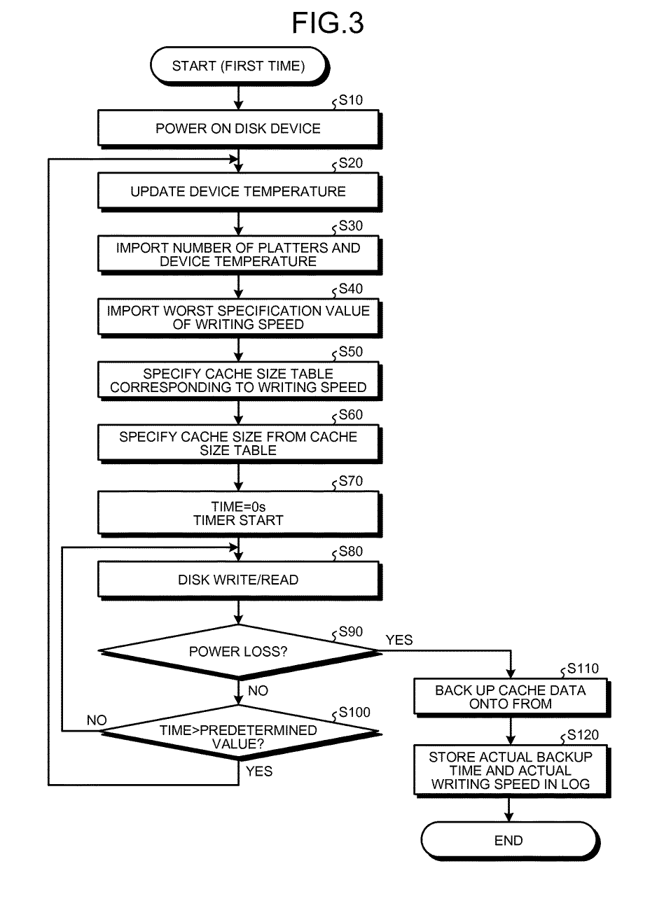

FIG. 3 is a flowchart of a process for saving data when the disk device 10 is first powered on. The HDC 17 detects the electric power source supplied from the host device HC, and determines whether the power source is turned on with the detected electric power source. When the disk device 10 is powered on (S10), a particular data item in the disk 11 or the FROM 26 is stored in the RAM 15. Specifically, the backup time table 51, the cache size table 52X, and the device information 54 are stored in the RAM 15.

The number of platters is a fixed value specific to the disk device 10. Hereinafter, an example in which the number of platters is one in the disk device 10 will be described. Thus, the number of platters of “one” and the worst specification value of the writing speed are stored as the device information 54 in the RAM 15.

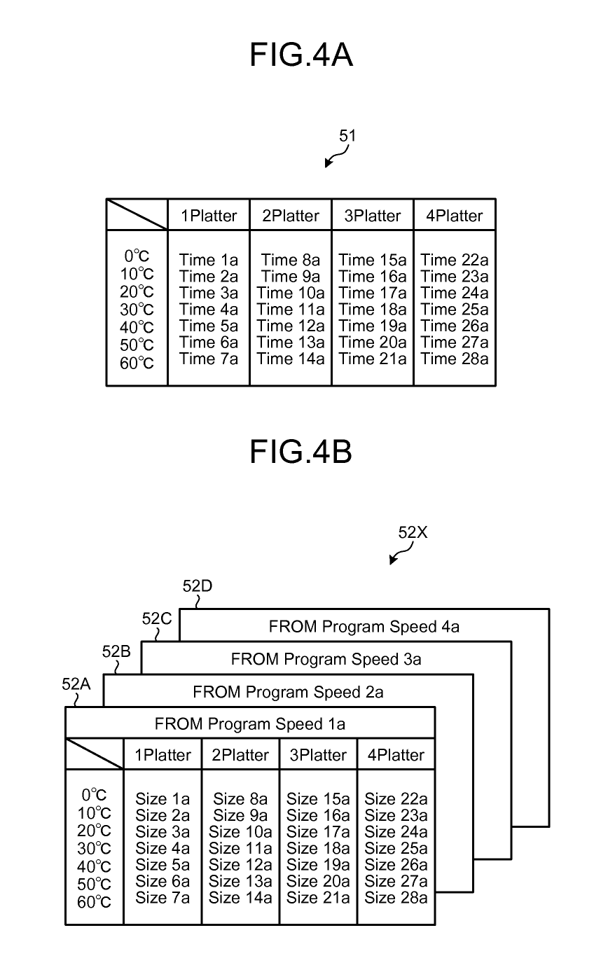

The configurations of the backup time table 51 and the cache size table 52X that are initial tables will be described hereinafter. FIGS. 4A and 4B are diagrams exemplary configurations of the initial tables. FIG. 4A illustrates the configuration of the backup time table 51 of the initial tables. FIG. 4B illustrates the configuration of the cache size table 52X of the initial tables.

A combination of a candidate for the number of platters and a candidate for the device temperature is corresponded to a candidate for the set backup time in the backup time table 51 illustrated in FIG. 4A. For example, when the number of platters is “one” and the device temperature is 0° C., the set backup time is “Time 1a”.

The cache size table 52X illustrated in FIG. 4B is formed by a plurality of cache size tables. In this example, the cache size table 52X is formed by four cache size tables 52A to 52D. The cache size table 52X is prepared for each of the writing speeds to the FROM 26. The writing speeds to the FROM 26 vary as different ranges. Thus, the cache size table 52X is formed by a plurality (for example, four types) of cache size tables. Note that the number of cache size tables forming the cache size table 52X can be equal to or smaller than three or equal to or larger than five.

The cache size table 52A is a cache size table when data is written to the FROM 26 at the writing speed of a first speed (Velocity 1a). The cache size table 52B is a cache size table when data is written to the FROM 26 at the writing speed of a second speed (Velocity 2a). The cache size table 52C is a cache size table when data is written to the FROM 26 at the writing speed of a third speed (Velocity 3a). The cache size table 52D is a cache size table when data is written to the FROM 26 at the writing speed of a fourth speed (Velocity 4a). Note that an example in which the first speed<the second speed<the third speed<the fourth speed holds will be described hereinafter.

Note that each of the device temperatures in the backup time table 51 and the cache size table 52A indicates a range of the device temperature. For example, the device temperature of 10° C. indicates the range of the temperatures of 10° C. or more and less than 20° C. The device temperature of 20° C. indicates the range of the temperatures of 20° C. or more and less than 30° C.

Similarly, the writing speed in the cache size table 52A indicates a range of the writing speed. For example, the second writing speed indicates a range of speeds from the first writing speed to the second writing speed. The third writing speed indicates a range of speeds from the second writing speed to the third writing speed.

In each of the cache size tables 52A to 52D, a combination of a candidate for the number of platters and a candidate for the device temperature is corresponded to a candidate for the backup size. The backup size is the amount of write cache data that can be backed up onto the FROM 26 when Power Loss occurs (the amount of PLP backup). The size of the cache 55 is adjusted so as to be equal to or smaller than the backup size. Each of the cache size tables 52A to 52D is generated based on the backup time table 51 and the writing speeds to the FROM 26.

Specifically, the cache size tables 52A to 52D show the items each obtained by multiplying the set backup time registered in the backup time table 51 by the writing speed to the FROM 26.

For example, when data is written to the FROM 26 at the writing speed that is the Nth (N is one of the first to fourth) speed, each of the set backup times registered in the backup time table 51 is multiplied by the Nth speed, and subsequently the cache size table 52X is generated. When N=1 holds, the cache size table 52A is generated. When N=2 holds, the cache size table 52B is generated. When N=3 holds, the cache size table 52C is generated. When N=4 holds, the cache size table 52D is generated.

For example, the cache size table 52A shows that the backup size is “Size 1a” when the number of platters is “one” and the device temperature is 0° C. In the present embodiment, the backup time table 51 and the cache size table 52X are previously generated and stored in the disk 11.

The backup time table 51 is generated based on the device temperature and the number of platters. The cache size table 52X showing the experimental values of the cache size is generated based on a combination of three parameters of the device temperature, the number of platters, and the writing speed.

Both of the backup time table 51 and the cache size table 52X are read from the disk 11 or the FROM 26 and stored in the RAM 15 when the disk device 10 is powered on.

With reference to FIG. 3 again, the HDC 17 measures the device temperature using the temperature sensor 25 after the disk device 10 is powered on. The measured device temperature is transmitted to the HDC 17. Then, the device temperature is updated (S20). The HDC 17 reads the device information 54 from the RAM 15. As described above, the device temperature and the number of platters of “one” is imported in the HDC 17 (S30).

Then, the HDC 17 specifies the writing speed. At that time, the writing speed is not yet determined. Thus, the HDC 17 imports the worst specification value of the writing speed from the device information 54 (S40). In this example, the first speed is the lowest speed among the first to fourth speeds and, accordingly, the first speed is the worst specification value.

The HDC 17 specifies the cache size table corresponding to the worst specification value (the cache size table 52A in this example) in the cache size table 52X (S50).

Subsequently, the HDC 17 specifies the cache size corresponding to the device temperature and the number of platters from the cache size table 52A in accordance with the device temperature and the number of platters (S60). Consequently, the HDC 17 sets the specified cache size as the size of the cache 55. This setting makes only the storage region of the set cache size used as a cache region in the storage region of the cache 55.

Furthermore, the HDC 17 starts measuring the time (Time=0 s, Timer Start) after updating the device temperature (S70). After that, the disk device 10 writes data to the disk 11 and reads data from the disk 11 (Disk Write/Read) (S80).

The HDC 17 determines whether Power Loss occurs while the disk device 10 operates (S90). The HDC 17 determines that Power Loss does not occur when the detected electric power source is at a level equal to or higher than a predetermined threshold level (S90, No). Subsequently, the HDC 17 determines whether the time elapsed from the start of the time measurement exceeds a predetermined value (Time>the predetermined value) (S100).

When Time≦the predetermined value holds (S100, No), the disk device 10 continues writing and reading data to and from the disk 11 (S80), and the HDC 17 continues determining again whether Power Loss occurs (S90).

If Power Loss does not occur, the disk device 10 repeats the process in S80 to S100 until Time>the predetermined value holds. When The Time>the predetermined value holds (S100, Yes) and Power Loss does not occur, the disk device 10 repeats the process in S20 to S100. When Time≦the predetermined value holds (S100, No), the disk device 10 continues writing and reading data to and from the disk 11, and determining whether Power Loss occurs (S80 and S90).

As described above, the device temperature often varies depending on the environment and the operation while the disk device 10 operates. Thus, the disk device 10 continues updating the device temperature at predetermined intervals of time (for example, 60 s). The disk device 10 can adjust the cache size to secure the maximum cache size under each condition by continuing referring to the cache size table 52X as described above.

When the detected electric power source is at a level lower than the predetermined threshold, the HDC 17 determines that Power Loss occurs (S90, Yes) and saves the data under the PLP control. In other words, the HDC 17 backs up (saves) the cache data (for example, the write data) in the cache 55 onto the FROM 26 by operating with the auxiliary power source (S110).

Furthermore, the HDC 17 specifies the time in which the backup is actually made (the actual backup time) based on the Assert period T1 of the Backup Enable signal after the Power Loss occurs. The HDC 17 calculates the writing speed at which the data is actually written to the FROM 26 (the actual writing speed) based on the accumulated time from the start of the writing. The disk device 10 records the accumulated time from the start of writing of data to the FROM 26 as a time stamp per predetermined size (for example, per Page). The HDC 17 calculates the writing speed by the predetermined size in accordance with the time stamp per predetermined size. Subsequently, the HDC 17 derives the actual writing speed to the FROM 26 using the writing speed by the predetermined size. Specifically, the HDC 17 sets the lowest writing speed (the worst value) as the actual writing speed among the writing speeds in the predetermined size. Consequently, the HDC 17 stores the specified actual backup time and actual writing speed as the log 53 in the FROM 26 (S120). The log 53 is referred to when the disk device is powered on next.

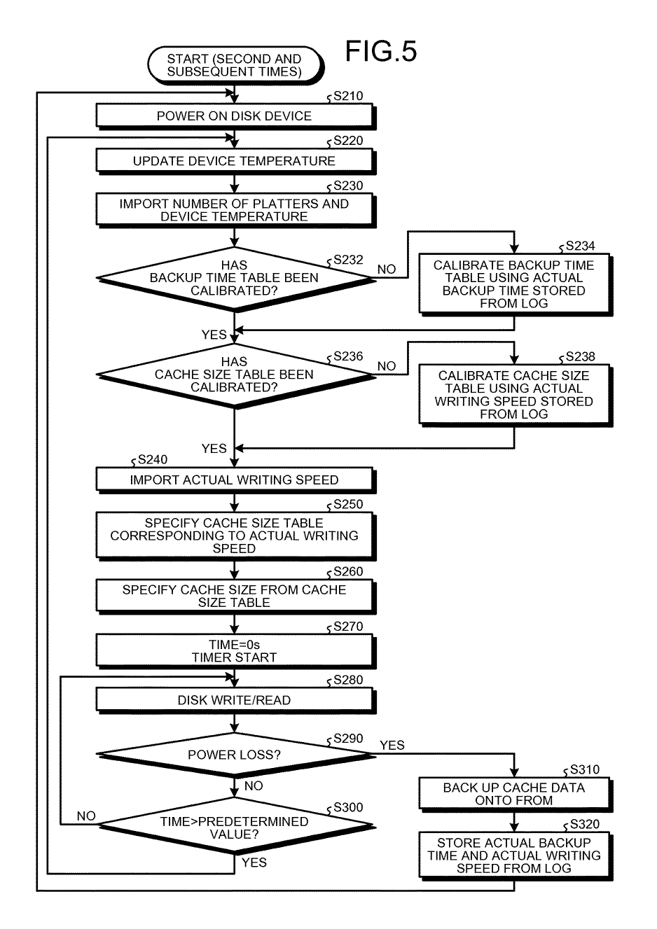

FIG. 5 is a flowchart of a process for saving data when the disk device is powered on for the second and subsequent times. The HDC 17 detects the electric power source supplied from the host device HC to determine whether the power source is turned on again in response to the supply of the detected electric power source. When the disk device 10 is powered on (S210), particular data items in the disk 11 is stored in the RAM 15. Specifically, the backup time tables 51 and 61, the cache size tables 52X and 62X, and the device information 54 are read from the disk 11 or the FROM 26 and stored in the RAM 15. Furthermore, the backed-up cache 55 is read from the FROM 26 and stored in the RAM 15.

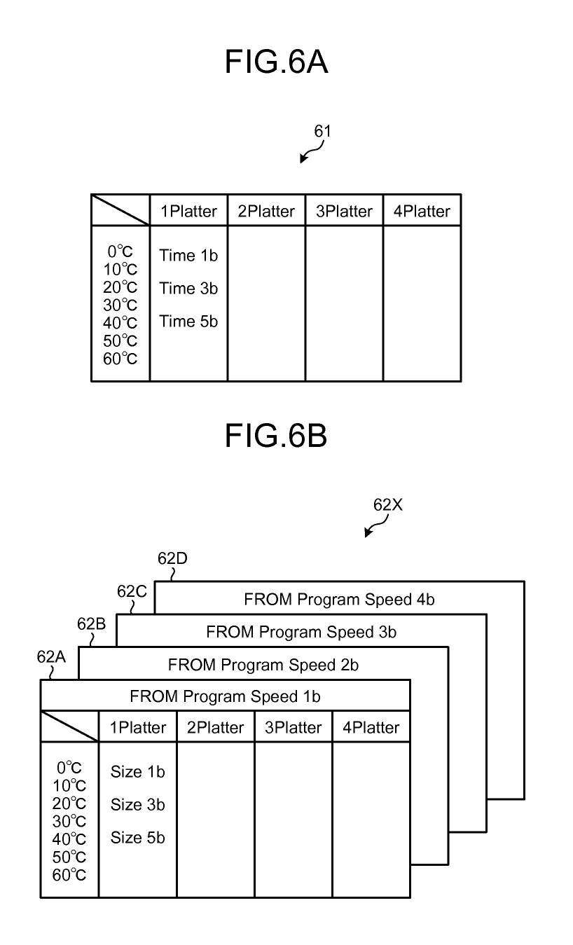

The configurations of the backup time table 61 and cache size table 62X that are update tables will be described hereinafter. FIGS. 6A and 6B are diagrams of exemplary configurations of the update tables. FIG. 6A illustrates the configuration of the backup time table 61 of the update tables. FIG. 6B illustrates the configuration of the cache size table 62X of the update tables.

The backup time table 61 illustrated in FIG. 6A is a table in which a combination of a candidate for the number of platters and a candidate for the device temperature is corresponded to a candidate for the set backup time. The backup time table 61 is generated in accordance with the backups actually made. Thus, no set backup time is set in the backup time table 61 in a state in which no backup is made (just after the disk device is first powered on). For example, when the number of platters is “1”, the device temperature is 20° C. and a backup is made, a set backup time (Time 3b) is stored in the backup time table 61 in accordance with the actual backup time of the backup. The set backup time set in the backup time table 61 needs to be equal to or shorter than the actual backup time.

The cache size table 62X illustrated in FIG. 6B is formed by a plurality of cache size tables. In this example, the cache size table 62X is formed by four cache size tables 62A to 62D. The cache size table 62X is prepared for each of the writing speeds to the FROM 26. The writing speeds to the FROM 26 vary as different ranges. Thus, the cache size table 62X is formed by a plurality (for example, four types) of cache size tables. Note that the number of cache size tables forming the cache size table 62X can be equal to or smaller than three or equal to or larger than five.

The cache size table 62A is a cache size table when a backup is actually made at the actual backup speed of a fifth speed (Velocity 1b). The cache size table 62B is a cache size table when a backup is actually made at the actual backup speed of a sixth speed (Velocity 2b). The cache size table 62C is a cache size table when a backup is actually made at the actual backup speed of a seventh speed (Velocity 3b). The cache size table 62D is a cache size table when a backup is actually made at the actual backup speed of an eighth speed (Velocity 4b).

Note that each of the device temperatures in the backup time table 61 and the cache size table 62X indicates the ranges of the device temperature. For example, the device temperature of 10° C. indicates the range of the temperatures of 10° C. or more and less than 20° C. The device temperature of 20° C. indicates the range of the temperatures of 20° C. or more and less than 30° C.

Similarly, each of the writing speeds in the cache size table 62X indicates a range of the writing speed. For example, the eighth writing speed indicates a range of speeds from the seventh writing speed to the eighth writing speed. The seventh writing speed indicates a range of speeds from the sixth writing speed to the seventh writing speed.

In each of the cache size tables 62A to 62D, a combination of a candidate for the number of platters and a candidate for the device temperature is corresponded to a candidate for the backup size. The cache size tables 62A to 62D are generated in accordance with the backups actually made. Thus, when no backup is made (just after the disk device is first powered on), no backup size is set in the cache size table 62X.

For example, when the number of platters is “one”, the device temperature is 20° C. and a backup is made, a backup size (Size 3b) is stored in accordance with the writing speed at which the backup is made at that time (the actual backup time). The backup size set in the cache size table 62X needs to be equal to or smaller than the value obtained by multiplying the actual backup time by the actual backup speed. The cache size tables 62A to 62D are generated based on the backup time table 61 and the actual backup speeds.

Specifically, items each obtained by multiplying the set backup time registered in the backup time table 61 by the actual backup speed are stored in the cache size tables 62A to 62D.

For example, when a backup is made at the actual backup speed that is the Mth (M is one of the fifth to eighth) speed, each of the set backup times registered in the backup time table 61 is multiplied by the Mth speed, and subsequently the cache size table 62X is generated. When M=5 holds, the cache size table 62A is generated. When M=6 holds, the cache size table 62B is generated. When M=7 holds, the cache size table 62C is generated. When M=8 holds, the cache size table 62D is generated.

For example, the cache size table 62A shows that the backup size is “Size 1b” when the number of platters is “one” and the device temperature is 0° C. The backup time table 61 and the cache size table 62X are updated every time a backup is made in the present embodiment. The backup time table 61 and the cache size table 62X are updated in the RAM 15 and stored in the disk 11 at a predetermined time.

The backup time table 61 is generated based on the device temperature, the number of platters, and the actual backup time. Similarly, the cache size table 62X is generated based on the combination of three parameters of the device temperature, the number of platters, and the actual writing speed.

Both of the backup time table 61 and the cache size table 62X are read from the disk 11 or the FROM 26 and stored in the RAM 15 when the disk device 10 is powered on.

With reference to FIG. 5 again, the HDC 17 measures the device temperature using the temperature sensor 25 after the disk device 10 is powered on. The measured device temperature is transmitted to the HDC 17. Then, the device temperature is updated (S220). The HDC 17 reads the device information 54 from the RAM 15. As described above, the device temperature and the number of platters of “one” are imported in the HDC 17 (S230).

The HDC 17 determines whether the backup time table 61 is calibrated (S232). When the backup time table 61 is not calibrated (S232, No), the HDC 17 calibrates the backup time table 61 using the actual backup time stored in the log 53 (S234).

After the backup time table 61 is calibrated (Yes in S232 or after S234), the HDC 17 determines whether the cache size table 62X is calibrated (S236).

When the cache size table 62X is not calibrated (S236, No), the HDC 17 calibrates the cache size table 62X using the actual backup speed stored in the log 53 and the backup time table 61 (S238).

After the cache size table 62X is calibrated (Yes in S236, or after S238), the HDC 17 specifies the writing speed. The HDC 17 imports the actual writing speed from the log 53 (S240).

The HDC 17 specifies the cache size table corresponding to the actual writing speed (for example, the cache size table 62A) among the cache size tables 62X (S250).

The HDC 17 specifies the cache size appropriate for the device temperature and the number of platters from the cache size table 62A in accordance with the device temperature, and the number of platters (S260).

Subsequently, the HDC 17 sets the specified cache size as the size of the cache 55. This setting makes only the storage region of the set cache size used as a cache region in the storage region of the cache 55.

After that, the process similar to the process in S70 to S120 is performed (S270 to S320). Power Loss occurs. A backup is made, and the actual backup time and the actual writing speed are stored as the log 53. Then, the disk device 10 is powered off. After that, the disk device 10 repeats the process in S210 to S320.

When the disk device is powered on for the third and subsequent times and the cache size can be specified in the cache size table 62X, the HDC 17 specifies the cache size using the cache size table 62X. Specifically, when the cache size appropriate for the number of platters, the device temperature, and the writing speed are stored in the cache size table 62X, the HDC 17 specifies the cache size with reference to the cache size table 62X. On the other hand, when the HDC 17 does not specify the cache size in the cache size table 62X, the HDC 17 specifies the cache size using the cache size table 52X.

The HDC 17 records the log 53 every time Power Loss occurs to update the backup time table 61 and the cache size table 62X. This update can maximize the cache size with reference to the cache size table 62X and improve the accuracy of specifying the cache size.

Note that, when the disk device 10 includes a battery or a capacitor, the disk device 10 can use the electricity supplied from the battery or the capacitor as an auxiliary power source in addition to or in place of the back electromotive force by the rotation of the spindle motor 12.

The example in which the cache data is backed up onto the FROM 26 has been described in the present embodiment. However, data other than the cache data in the RAM 15 can be backed up onto the FROM 26.

When the storage device is an SSD, the storage device includes a non-volatile storage device such as a NAND memory. Then, the storage device uses, for example, the NAND memory in place of the disk 11.

Alternatively, the backup time tables 51 and 61, and the cache size tables 52X and 62X can be for a certain number of platters. In such a case, the backup time tables 51 and 61, and cache size tables 52X and 62X appropriate to the number of platters of the disks 11 are generated.

As described above, the disk device 10 dynamically controls the size of the cache 55. In other words, the disk device 10 variably adjusts the size of the cache 55 that is initially a fixed value so as to maximize the size in accordance with the condition.

According to the embodiment, the cache size of the cache 55 is adjusted based on the device temperature of the disk device 10 and the writing speed at which data is written to the FROM 26. This adjustment enables the disk device 10 to set an appropriate cache size.

Setting a cache size appropriate to the disk device 10 can prevent the disk device 10 from decreasing the cache performance. This reduces the number of times that the disk 11 is accessed. As a result, this can achieve low power consumption in disk device 10. Furthermore, setting a cache size appropriate to the disk device 10 improves the reliability of cache data maintainability even if Power Loss occurs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device connected to a host device, the storage device comprising:
a non-volatile storage unit that stores data from the host device;
a cache memory that temporarily stores the data before the data is stored in the non-volatile storage unit;
a non-volatile memory that backs up data in the cache memory using an auxiliary power source when power loss occurs; and
a controller that stores data from the host device in the cache memory, subsequently stores the data in the non-volatile storage unit and, when the power loss occurs, backs up the data in the cache memory onto the non-volatile memory using the auxiliary power source, wherein
the controller adjusts a set size of the cache memory based on a device temperature near the storage device and a writing speed at which data is written to the non-volatile memory.

2. The storage device according to claim 1, wherein the non-volatile storage unit is a disk, and
the auxiliary power source is a back electromotive force by rotation of a spindle motor.

3. The storage device according to claim 1, wherein the controller specifies a backup time that is a time in which the data is able to be backed up based on the device temperature, and adjusts the set size based on the backup time and the writing speed to the non-volatile memory.

4. The storage device according to claim 1, wherein the controller adjusts the set size with reference to a cache size table in which a candidate for the device temperature is corresponded to a candidate for a cache size.

5. The storage device according to claim 4, wherein the cache size table includes an update table that is updated in accordance with a backup actually made, and
the controller updates the update table in the cache size table in accordance with the backup actually made, and adjusts the set size with reference to the updated update table.

6. The storage device according to claim 4, wherein the non-volatile storage unit is one or more disks,
the candidate for the cache size is set for combination of the candidate for the device temperature and a candidate for the number of the disks in the cache size table, and
the controller adjusts the set size based on an actual number of the disks and the device temperature.

7. The storage device according to claim 4, wherein a candidate for the cache size is set for combination of the candidate for the device temperature and a candidate for the writing speed in the cache size table, and
the controller adjusts the set size based on the writing speed to the non-volatile memory and the device temperature.

8. The storage device according to claim 4, wherein the cache size table includes an initial table generated before the storage device is first powered on, and
the controller adjusts the set size with reference to the initial table.

9. The storage device according to claim 4, wherein the cache size table includes a first table generated before the storage device is first powered on, and a second table generated in accordance with a backup actually made, and
the controller
adjusts the set size with reference to the second table when the set size appropriate for the device temperature of the storage device and the writing speed to the non-volatile memory is registered in the second table, and
adjusts the set size with reference to the first table when the set size appropriate for the device temperature of the storage device and the writing speed to the non-volatile memory is not registered in the second table.

10. The storage device according to claim 3, wherein the controller specifies the backup time with reference to a backup time table in which a candidate for the device temperature is corresponded to a candidate for the backup time.

11. A data save method comprising:
storing data from a host device in a non-volatile storage unit after temporarily storing the data in a cache memory;
adjusting a set size of the cache memory based on a device temperature near a storage device and a writing speed at which data is written to a non-volatile memory, the storage device being connected to the host device and including the non-volatile memory; and
backing up data in the cache memory onto the non-volatile memory using an auxiliary power source when power loss occurs.

12. The data save method according to claim 11, wherein the non-volatile storage unit is a disk, and
the auxiliary power source is a back electromotive force by rotation of a spindle motor.

13. The data save method according to claim 11, the method comprising:
specifying a backup time that is a time in which the data is able to be backed up based on the device temperature; and
adjusting the set size based on the backup time and the writing speed to the non-volatile memory.

14. The data save method according to claim 11, the method comprising:
adjusting the set size with reference to a cache size table in which a candidate for the device temperature is corresponded to a candidate for a cache size.

15. The data save method according to claim 14, wherein the cache size table includes an update table that is updated in accordance with a backup actually made, the method comprising:
updating the update table in the cache size table in accordance with the backup actually made; and
adjusting the set size with reference to the updated update table.

16. The data save method according to claim 14, wherein the non-volatile storage unit is one or more disks, and
the candidate for the cache size is set for combination of the candidate for the device temperature and a candidate for the number of the disks in the cache size table, the method comprising:
adjusting the set size based on an actual number of the disks and the device temperature.

17. The data save method according to claim 14, wherein a candidate for the cache size is set for combination of the candidate for the device temperature and a candidate for the writing speed in the cache size table, the method comprising:
adjusting the set size based on the writing speed to the non-volatile memory and the device temperature.

18. The data save method according to claim 14, wherein the cache size table includes an initial table generated before the storage device is first powered on, the method comprising:
adjusting the set size with reference to the initial table.

19. The data save method according to claim 14, wherein the cache size table includes a first table generated before the storage device is first powered on and a second table generated in accordance with a backup actually made, the method comprising:
adjusting the set size with reference to the second table when the set size appropriate for the device temperature of the storage device and the writing speed to the non-volatile memory is registered in the second table; and
adjusting the set size with reference to the first table when the set size appropriate for the device temperature of the storage device and the writing speed to the non-volatile memory is not registered in the second table.

20. The data save method according to claim 13, the method comprising:
specifying the backup time with reference to a backup time table in which a candidate for the device temperature is corresponded to a candidate for the backup time.
